(19) United States
(12) Patent Application Publication
(10) Pub. No.: US 2013/0240052 A1
(43) Pub. Date: Sep. 19, 2013

(54) GATE VALVE ASSEMBLIES AND METHODS OF USE

(71) Applicant: Troy J. Bengtzen, Holladay, UT (US)

(72) Inventor: Troy J. Bengtzen, Holladay, UT (US)

(21) Appl. No.: 13/607,466

(22) Filed: Sep. 7, 2012

Related U.S. Application Data
(60) Provisional application No. 61/533,094, filed on Sep. 9, 2011.

(51) Int. Cl. F16K 31/50

(52) U.S. Cl. CPC F16K 31/502
USPC 137/15.23; 251/266

(57) ABSTRACT

In an embodiment, a valve assembly may include a housing having a orifice defining a flow path through the housing and a valve closure element positioned within the housing configured to control fluid flow through the housing. The valve closure element may include a side surface and drive teeth extending along at least a portion of the side surface. The valve closure element may be selectively rotatable about a rotation axis between an open position, wherein fluid flows through the orifice, and a closed position, wherein fluid flow is substantially obstructed by the valve closure element. The valve assembly may also include a worm gear assembly positioned and configured to selectively engage or mesh with one or more of the drive teeth such that rotation of the worm gear assembly may rotate the valve closure element between the closed position and the open position.

### CROSS-REFERENCE TO RELATED APPLICATIONS

This application claims the benefit of U.S. Provisional Patent Application No. 61/533,094, entitled “PIVOTING GATE VALVE,” filed Sep. 9, 2011, the content of which is incorporated herein, in its entirety, by this reference.

### BACKGROUND

Valves are commonly used in industry for isolating process media, fluids, and/or gases. Valves may also be used in industry for controlling the flow of low or high pressure process media, fluids, and/or gases in a process system. In many applications, such valves are subject to severe operating conditions such as high temperatures, high pressures, abrasives, corrosives, toxic materials, residual build-up, debris, and/or vibration. Consequently, there may be severe energy drops or pressure losses across the valve or excessive build-up in the valve, which may cause vibration, cavitation, and/or blockage, each of which may damage the valve and/or cause excessive noise in the process system. Further, as the valve is damaged, the flow characteristics of the valve may be abruptly altered or gradually altered over time. The altered flow characteristics may be unpredictable, dangerous, and/or erratic, thus greatly complicating operation of the process system and/or maintenance of the valve. Moreover, in some cases, altered flow characteristics and/or valve damage may ultimately cause failure of the valve, thereby jeopardizing human safety and/or the integrity of the process system.

Therefore, manufacturers and users of valves continue to seek improved valve designs and methods of use.

### SUMMARY

Embodiments of the invention relate generally to gate valve assemblies and methods of use. In an embodiment, a valve assembly may include a housing having an orifice defining a flow path through the housing and a valve closure element positioned within the housing configured to control fluid flow through the housing. The valve closure element may include a side surface and drive teeth extending along at least a portion of the side surface. The valve closure element may be selectively rotatable about a rotation axis between an open position, wherein fluid flows through the orifice, and a closed position, wherein fluid flow is substantially obstructed by the valve closure element. The valve assembly may also include a worm gear assembly positioned and configured to selectively engage or mesh with one or more of the drive teeth such that rotation of the worm gear assembly may rotate the valve closure element between the closed position and the open position.

In an embodiment, a valve assembly may include a valve body having a flow orifice extending therethrough. Valve assembly may also include a first valve bonnet removably coupled to a first end of the valve body and a second valve bonnet removably coupled to a second end of the valve body. In addition, valve assembly may include a valve chamber at least partially defined by the valve body and the valve bonnets. An elliptical or kidney-like shaped gate may be positioned within the chamber and configured to control fluid flow through the flow orifice. The gate may include a gate orifice extending therethrough, a side surface, and a plurality of gate drive teeth extending along at least a portion of the side surface of the gate. The gate may be selectively rotatable about a rotation axis between an open position, wherein the flow orifice and the gate orifice are at least partially aligned, and a closed position, wherein a solid portion of the gate obstructs the flow orifice. The valve assembly may further include a worm gear assembly positioned and configured to selectively engage or mesh with one or more of the drive teeth. Rotation of the worm gear assembly may rotate gate about the rotation axis to move the gate between the closed position and the open position. Finally, valve assembly may include a seat assembly positioned within the chamber and configured to form and/or maintain a seal between the gate and seat assembly.

In an embodiment, a method of controlling fluid flow through a gate valve may include connecting a gate valve to a vessel, coupling, or a pipeline. The gate valve may include a housing having an orifice defining a flow path through the gate valve. A gate may be positioned within the housing and configured to control process media flow through the gate valve. The gate may include a side surface and a plurality of gate drive teeth extending along at least a portion of the side surface. The gate may be selectively rotatable about a rotation axis between an open position, wherein process media flows through the gate valve, and a closed position, wherein process media flow through the gate valve is substantially obstructed by the gate. The gate valve may further include a worm gear assembly positioned and configured to selectively engage one or more of the gate drive teeth. Rotation of the worm gear assembly may rotate the gate about the rotation axis to move the gate between the closed and open positions. An actuator may be operably connected to the worm gear assembly. The actuator may be configured to control rotation of the worm gear assembly to move the gate between the open and closed position. The method may further include controlling process media flow through the gate valve by controlling the worm gear assembly with the actuator.

Features from any of the disclosed embodiments may be used in combination with one another, without limitation. In addition, other features and advantages of the present disclosure will become apparent to those of ordinary skill in the art through consideration of the following detailed description and the accompanying drawings.

### BRIEF DESCRIPTION OF THE DRAWINGS

The drawings illustrate several embodiments of the invention, wherein identical reference numerals refer to identical elements or features in different views or embodiments shown in the drawings.

FIG. 1A is a perspective view of a valve assembly according to an embodiment.

FIG. 1B is cross-sectional view of the valve assembly shown in FIG. 1A taken along section line 1B-1B.

FIG. 1C is a perspective view of the valve assembly shown in FIG. 1A in a closed position according to an embodiment;

FIG. 1D is a perspective view of the valve assembly shown in FIG. 1A in an open position according to an embodiment;

FIG. 2 is a perspective view of a gate according to an embodiment;

FIG. 3 is a perspective view of a gate according to another embodiment;

FIG. 4 is a perspective view of a gate according to another embodiment;

FIG. 5 is a partial perspective view of a valve assembly that illustrates a gate drive system according to an embodiment;

FIG. 6 is a perspective view of a valve body according to an embodiment;

FIG. 7 is a perspective view of a connection between valve body and a valve bonnet according to an embodiment;

FIG. 8 is a partial perspective view of a valve assembly that illustrates an indicator according to an embodiment;

FIG. 9 is a perspective view of a valve bonnet according to an embodiment;

FIG. 10A is a perspective view of a seat assembly according to an embodiment;

FIG. 10B is a cross-sectional view of seats according to an embodiment;

FIG. 10C is a cross-sectional view of seats according to another embodiment;

FIG. 10D is a cross-sectional view of seats according to another embodiment;

FIG. 10E is a cross-sectional view of seats according to another embodiment;

FIG. 10F is a cross-sectional view of seats according to another embodiment;

FIG. 10G is a cross-sectional view of seats according to another embodiment;

FIG. 10H is a cross-sectional view of seats according to another embodiment; and

FIG. 11 is a partial perspective view of a valve assembly that illustrates support members according to an embodiment.

### DETAILED DESCRIPTION

Embodiments of the invention relate generally to gate valve assemblies and methods of use for isolation and control applications. More specifically, embodiments of the invention relate to gate valve assemblies configured to be tight sealing, low maintenance, durable, and more efficient to operate.

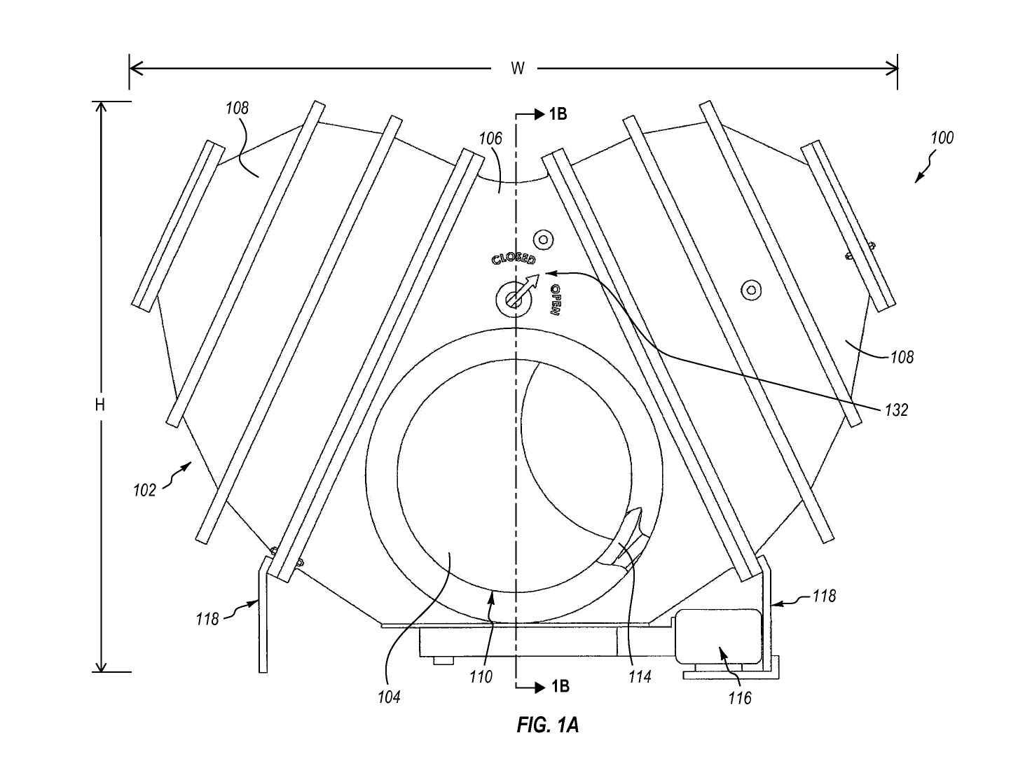

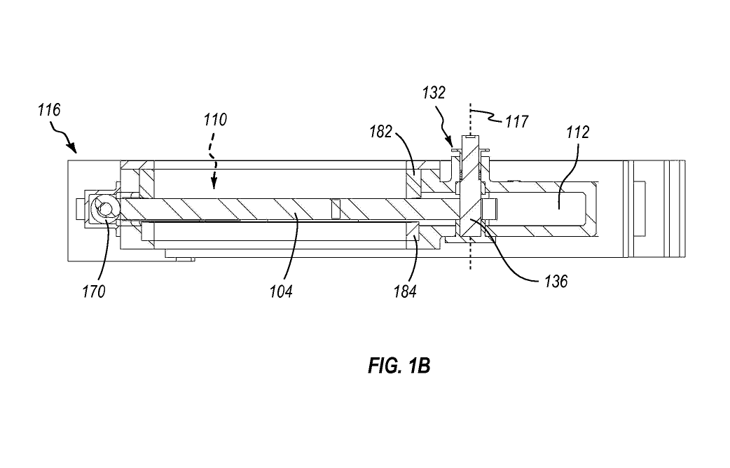

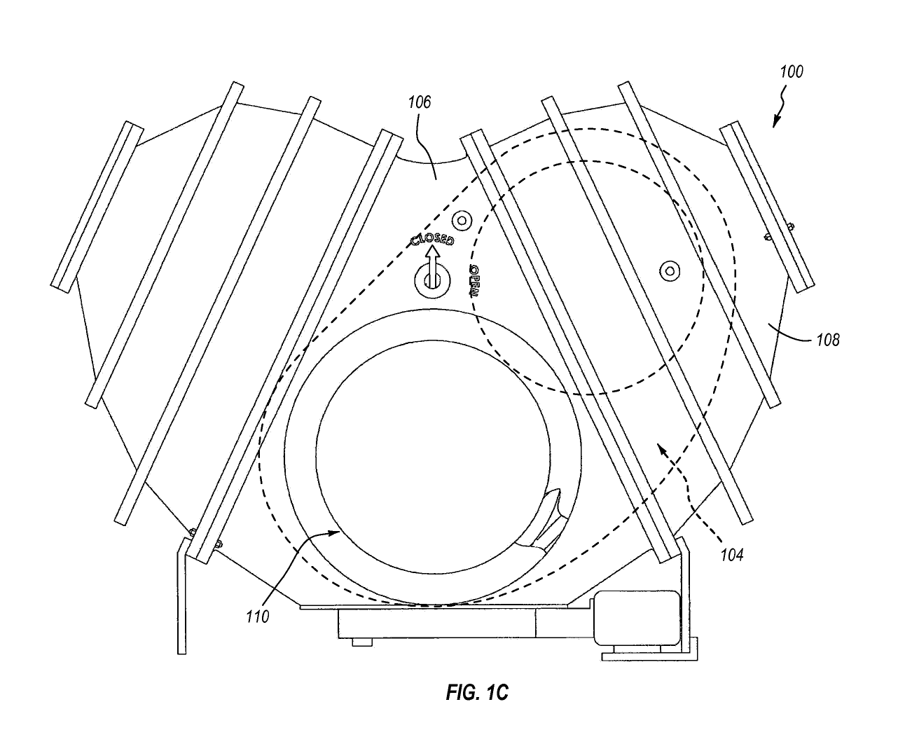

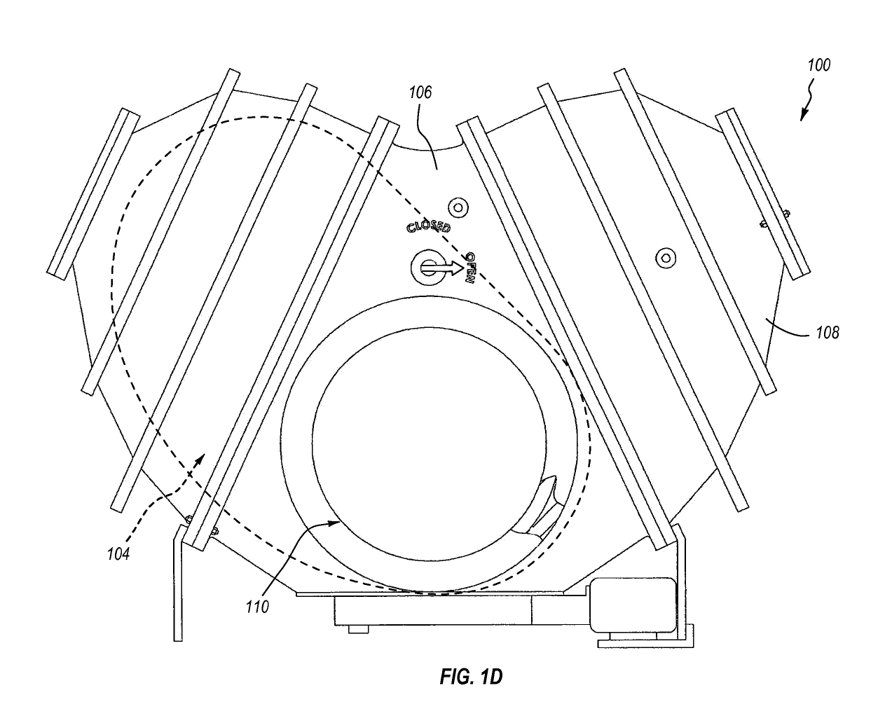

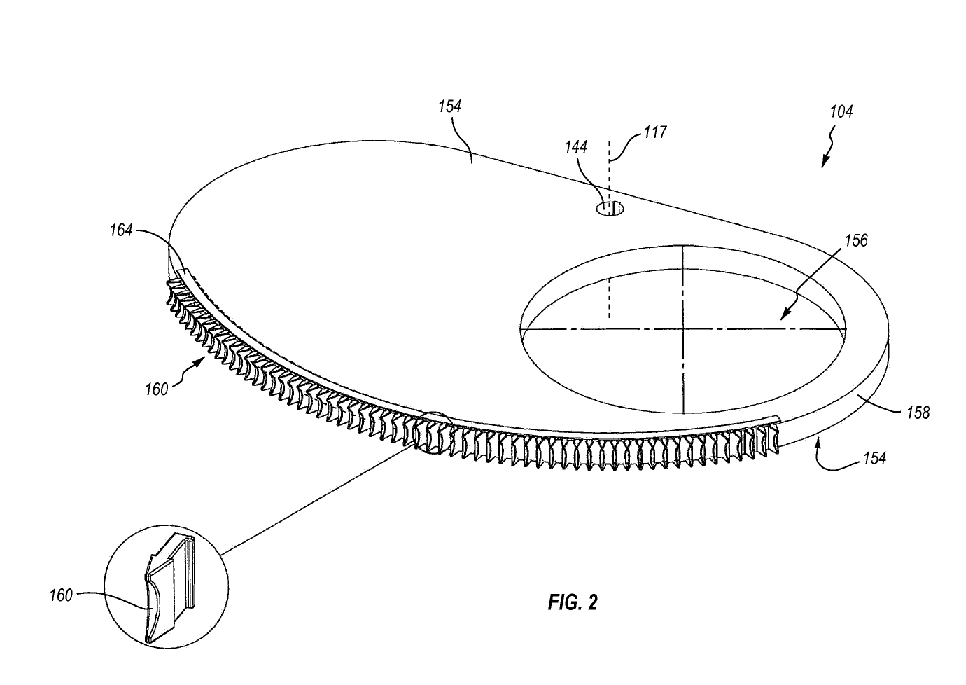

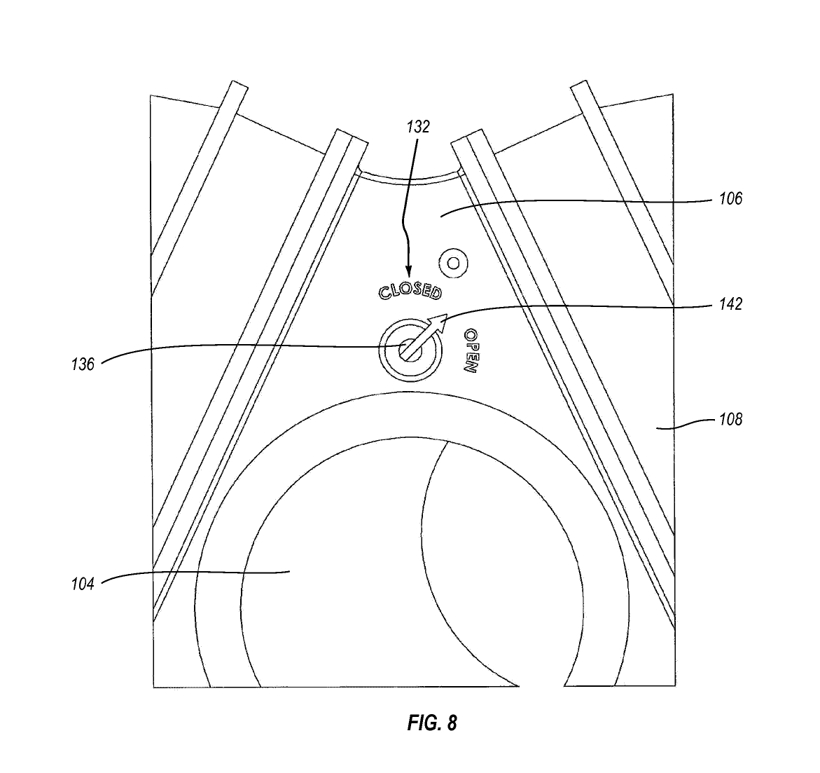

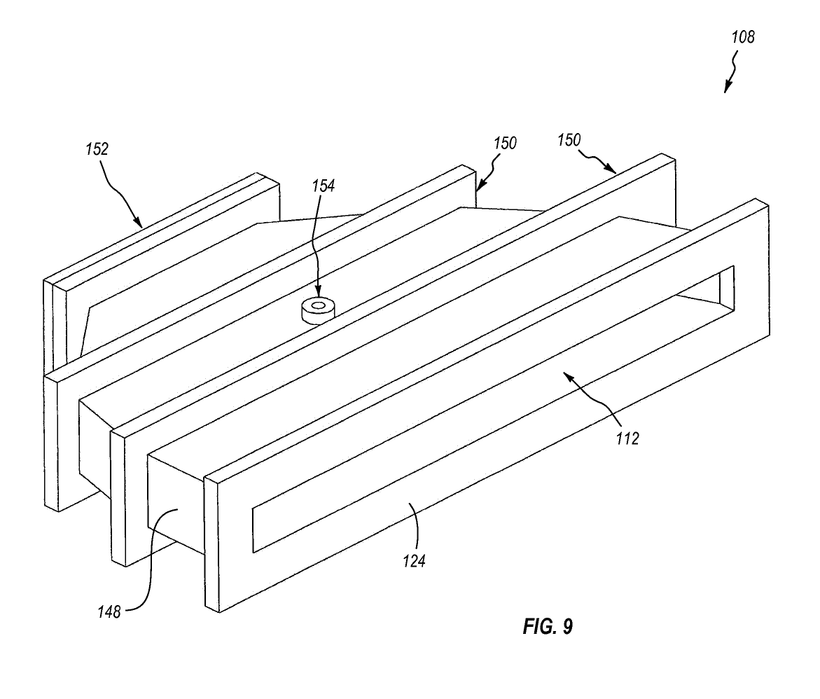

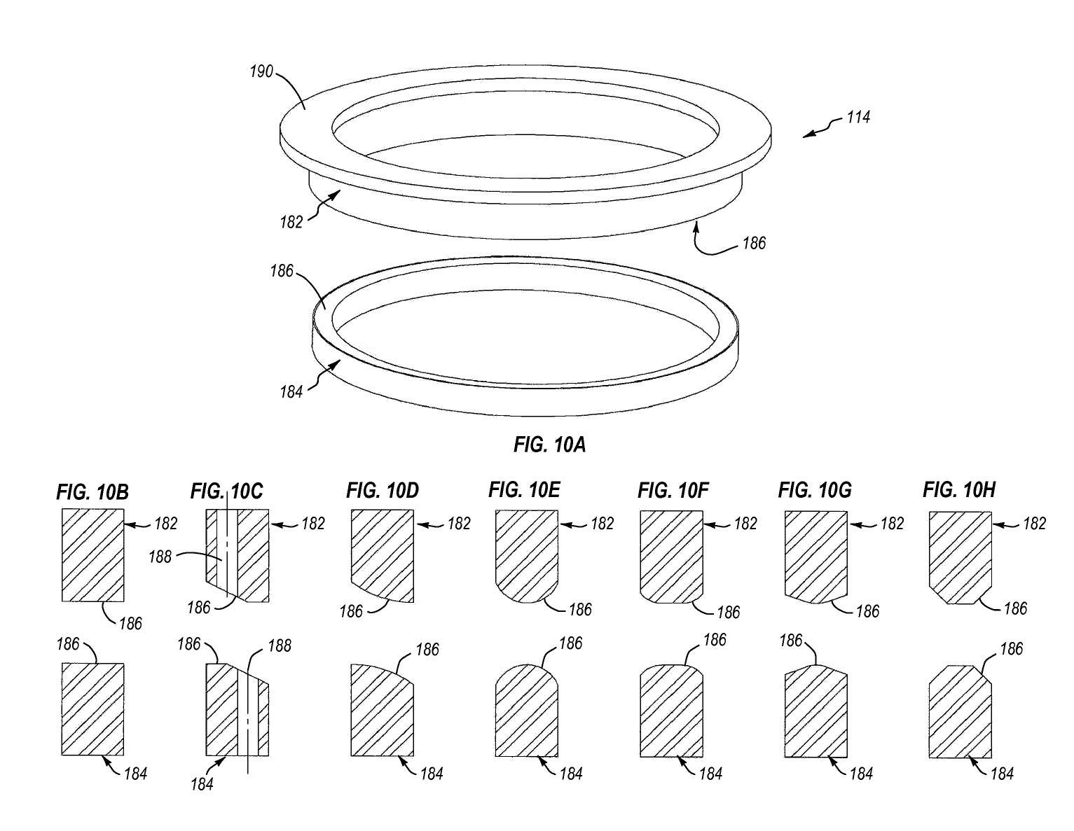

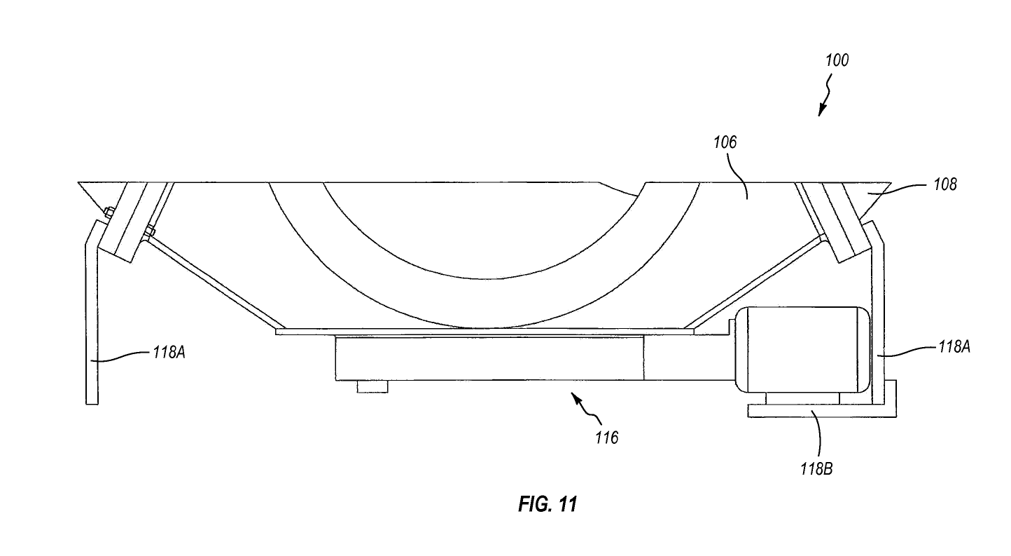

FIGS. 1A and 1B are perspective and cross-sectional views, respectively, of an embodiment of a valve assembly 100. The valve assembly 100 may include a housing 102 and a valve closure element or gate 104. In an embodiment, housing 102 may comprise a valve body 106 and valve bonnets 108 removably coupled to opposing ends of valve body 106. As shown, valve body 106 may include a generally cylindrical orifice 110 that defines a flow path through valve body 106. A valve chamber 112 may be at least partially defined within valve body 106 and valve bonnets 108. Valve chamber 112 may generally traverse the flow path through orifice 110 and may be configured to house at least gate 104 and a seat assembly 114 configured to form and/or maintain a seal between at least gate 104, valve body 106, and seat assembly 114. In an embodiment, gate 104 may be connected to a pivot point shaft 136. As described in more detail below, gate 104 may be selectively rotatable about a rotation axis 117 to move or slide gate 104 between an open position, wherein fluid may flow through orifice 110 (shown in FIGS. 1A and 1C), and a closed position, wherein fluid flow through orifice 110 is substantially obstructed by gate 104 (shown in FIG. 1D). Gate 104 may slide or move from the open to closed position and back, between two sealing surfaces or seats 182, 184 (shown in FIG. 10) of the seat assembly 114. Gate 104 may include a plurality of gate drive teeth 160 (shown in FIG. 2) extending along at least a portion of a side surface 158 (shown in FIG. 2) of gate 104. In an embodiment, valve assembly 100 may include a gate drive system 116 configured to engage one or more drive teeth of gate 104 to move or slide gate 104 between the open and closed positions. Valve assembly 100 may further include one or more support members 118 integral to or removably attached to valve bonnets 108 and/or valve body 106. Optionally, valve assembly 100 may further include a position indicator 132 configured to indicate whether gate 104 is in the open position, the closed position, or in some position in between.

Valve assembly 100 or any component thereof may be configured to be compliant with applicable valve design standards and/or codes for applications and/or services within which valve assembly 100 may operate. For example, one or more components of valve assembly 100 may be configured to operate under severe service conditions. In an embodiment, one or more components of valve assembly 100 may be configured to operate in temperatures between about negative one hundred and fifty (−150)° F. and about two thousand (2000)° F., about negative one hundred (−100)° F. and about fifteen hundred (1500)° F., or about negative fifty (−50)° F. and about twelve hundred (1200)° F. In other embodiments, one or more components of valve assembly 100 may be configured to operate in higher or lower temperatures.

In an embodiment, one or more components of valve assembly 100 may be configured to operate under pressures between vacuum and about forty-five hundred (4500) psi; between vacuum and about four thousand (4000) psi, about vacuum and about thirty-five hundred (3500) psi; about 0 psi and about three thousand (3000) psi, or about 0 psi and about twenty-five hundred (2500) psi. In other embodiments, one or more components of valve assembly 100 may be configured to operate under higher or lower pressures.

In yet other embodiments, one or more components of valve assembly 100 may be configured to handle abrasives, corrosives, solids, toxic materials, and/or other chemicals. Valve assembly 100 may include one or more high strength and/or chemical resistant materials. For example, one or more components of valve assembly 100 may include steel, galvanized steel, stainless steel, iron, ductile iron, carbon steel, gun metal, alloy steel, alloy steels, one or more metal alloys, one or more polymeric materials, rubber, ceramics, composite materials, brass, combinations thereof, or any other suitable material.

Valve assembly 100 may also be sized and configured for various different applications and/or services. For example, in an embodiment, valve assembly 100 may exhibit a height H between about a half (0.5) foot and about twenty (20) feet; between about one (1) foot and about twelve and a half (12.5) feet; or about three (3) feet and about ten (10) feet. In an embodiment, valve assembly 100 may exhibit a height H of about one (1) foot; of about five (5) feet; of about ten (10) feet; of about twelve and a half (12.5) feet; or about fifteen (15) feet. In other embodiments, valve assembly 100 may exhibit larger or smaller heights.

In an embodiment, valve assembly 100 may exhibit a width W between about a half (0.5) foot and about thirty (30) feet; between about one (1) foot and about twenty (20) feet; between about three (3) feet and about twelve and a half (12.5) feet; or about three (3) feet and about ten (10) feet. In other embodiments, valve assembly 100 may exhibit larger or smaller widths.

While housing 102 is illustrated having a generally truncated heart-like shape, in other embodiments housing 102 may have a generally rounded rectangular shape, a generally kidney shape, a generally elliptical shape, a symmetrical shape, an asymmetrical shape, combinations thereof, or any other suitable shape. Moreover, while housing 102 is illustrated as comprising valve body and separate valve bonnets, in other embodiments, housing 102 may comprise a valve body, a valve body and a single valve bonnet, or any other suitable number of members. Further, while valve bonnets 108 are illustrated as being generally identical or similar, in other embodiments, valve bonnets 108 may be different. For example, in an embodiment, one of the valve bonnets 108 may have a different size and/or shape than the other valve bonnet 108. In addition, while orifice 110 is illustrated being generally cylindrical, in other embodiments, orifice 110 may be generally rectangular, generally elliptical, generally oval, or any other suitable shape.

FIG. 2 illustrates gate 104 according to an embodiment. As noted above, gate 104 may be moveably positioned within valve chamber 112 and may be configured to selectively rotate about a rotation axis 117 to move or slide gate 104 between an open position, wherein process fluid and/or other materials may flow through orifice 110 (shown in FIG. 1A), and a closed position, wherein fluid flow through orifice 110 is substantially obstructed by gate 104. In an embodiment, gate 104 may be sized and configured to efficiently move through valve chamber 112. In an embodiment, gate 104 may exhibit a kidney-like shape that allows gate 104 to move between the open and closed positions while being supported within valve assembly 100 and occupying a limited amount of space within valve chamber 112 (shown in FIGS. 1C and 1D). For example, in an embodiment, gate 104 may be substantially removed from one of the bonnets 108 or substantially positioned in only valve body 106 and one of bonnets 108 in the closed position. Such a configuration may help reduce the overall weight of valve assembly 100. In an embodiment, gate 104 may move between the open and closed positions along an arcuate path such that the linear distance traveled by gate 104 is reduced. Moreover, the geometric shape of one or more portions of gate 104 may generally correspond to the geometric shape of valve chamber 112 to help gate 104 efficiently and/or smoothly move in and out of bonnets 108 as gate 104 moves between the open and closed positions.

While gate 104 is illustrated exhibiting a generally kidney-like shape, in other embodiments, gate 104 may exhibit a generally teardrop-like shape, a generally rounded rectangular shape, a generally elliptical shape, an asymmetrical shape, combinations thereof, or any other suitable shape.

In addition, gate 104 may include a pivot point shaft receiver 144 formed therein. As described in more detail below, pivot point shaft receiver 144 may be configured to receive pivot point shaft 136 (shown in FIG. 1B) connected to gate 104. Pivot point shaft 136 may define rotation axis 117 for gate 104. In an embodiment, when gate 104 and pivot point shaft 136 rotate about rotation axis 117, gate 104 may move between the open and closed positions. In other embodiments, pivot point shaft 136 may be fixedly attached to valve body 106 and gate 104 may be pivotally connected to pivot point shaft 136 such that gate 104 rotates about pivot point shaft 136.

In an embodiment, pivot point shaft receiver 144 may be offset from a geometric center of gate 104 such that rotation of gate 104 about the rotation axis defined by pivot point shaft 136 is asymmetrical. In other embodiments, pivot point shaft receiver 144 may be generally aligned with a geometric center of gate 104 such that rotation of gate 104 about the rotation axis is symmetrical. Gate 104 may further include a gate orifice 156 through which process media and/or other materials may flow when gate 104 is in an open position. For example, in an embodiment, gate orifice 156 may be at least partially aligned with orifice 110 in the open position. In other embodiments, gate orifice 156 may be substantially aligned with orifice 110 in the open position. In the closed position, gate orifice 156 may move inside of one of bonnets 108 and/or valve body 106 and a solid portion of gate 104 may obstruct flow through orifice 110. Accordingly, gate 104 may open and close valve assembly 100 without the entirety of gate 104 having to pass over the seats 182, 184 of seating assembly 114 and/or orifice 110. Such a configuration may reduce the overall size, weight, and/or cost of valve assembly 100. Gate orifice 156 may exhibit a circular cross-sectional shape and may include an inner diameter that is similar to an outer diameter of a process pipeline, coupling, or vessel to which valve assembly 100 is attached. In other embodiments, gate orifice 156 may exhibit other cross-sectional shapes. For example, in other embodiments, gate orifice 156 may exhibit a generally parabolic cross-sectional shape, a generally rectangular cross-sectional shape, a generally v-notch cross-sectional shape, or any other suitable cross-sectional shape.

Gate 104 may include seating surfaces 154 opposite one another and a side surface 158 extending between the seating surfaces 154. Seating surfaces 154 of gate 104 may be configured to contact seats 182, 184 of the seating assembly 114 to form a seal between the gate 104 and seating assembly 114. In an embodiment, seating surfaces 154 of gate 104 may be generally planar and generally parallel to one another. In other embodiments, one or more of seating surfaces 154 of gate 104 may be generally tapered or inclined such that gate 104 forms a wedge-like shape. Such a configuration may allow for sealing and/or seating forces to increase as more of gate 104 is rotated over seats 182, 184 of the seat assembly 114.

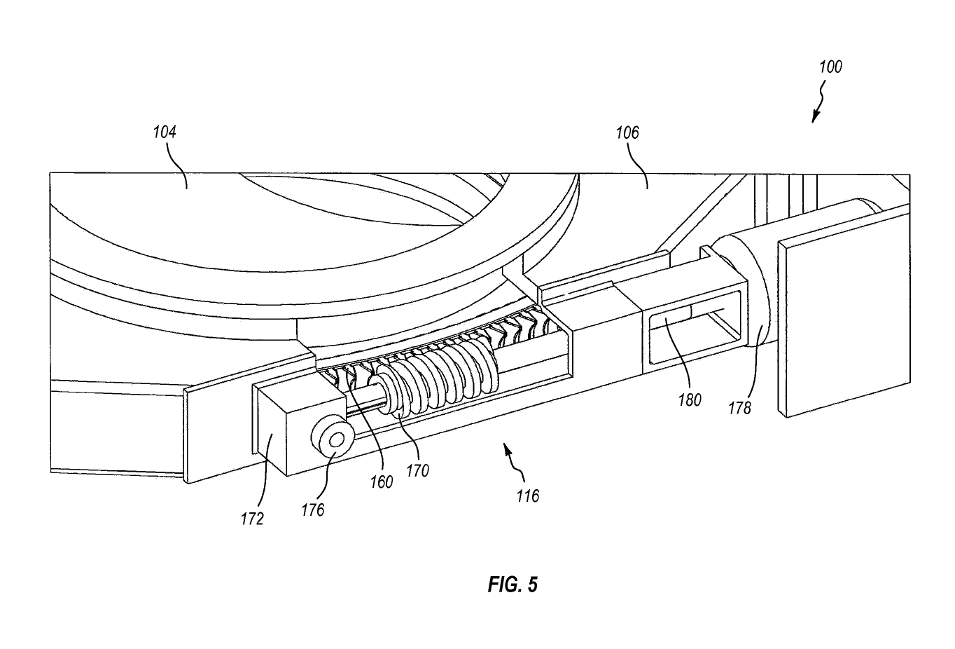

Gate 104 may include a plurality of gate drive teeth 160 extending along at least a portion of side surface 158 of gate 104. For example, gate drive teeth 160 may extend along a portion of side surface 158 near worm drive assembly 170 (shown in FIG. 5). In another embodiment, gate drive teeth 160 may extend along the entirety of the side surface 158 (e.g., the entire periphery of gate 104). In other embodiment, gate drive teeth 160 may extend along intermittent portions of side surface 158.

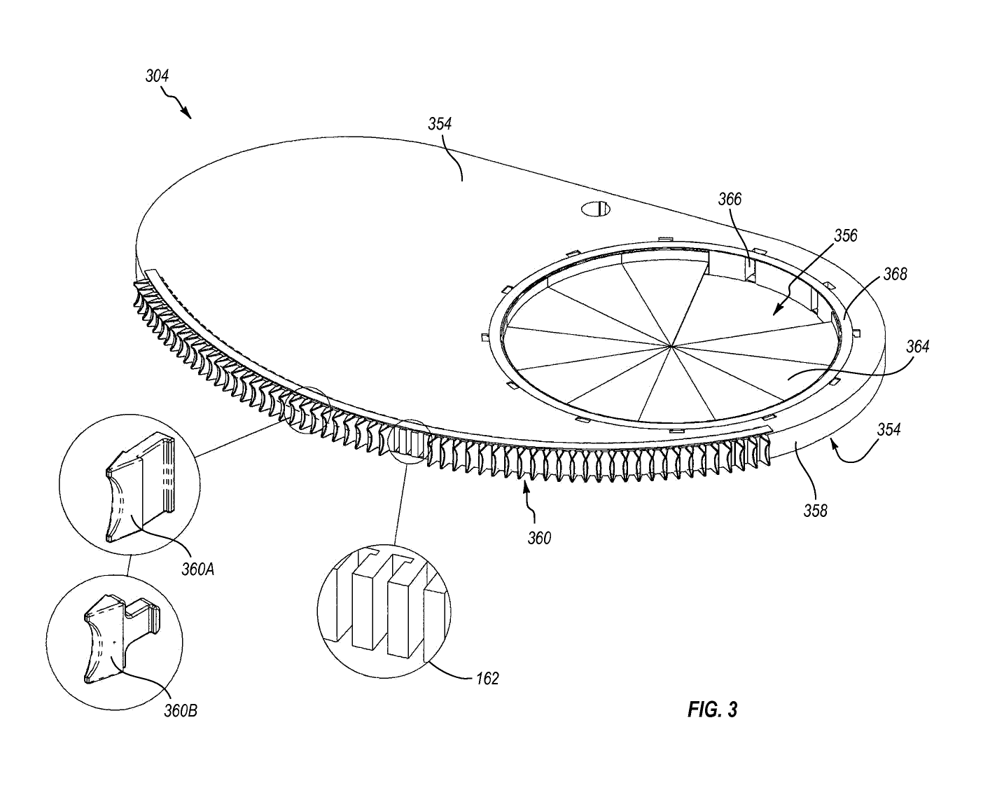

In an embodiment, gate drive teeth 160 may be configured to engage or mesh with worm gear assembly 170 (shown in FIG. 5) such that rotation of worm gear assembly 170 rotates gate 104 about rotation axis 117 to move gate 104 between the open and closed positions. In an embodiment, one or more of gate drive teeth 160 may be integral to side surface 158 of gate 104. In other embodiments, one or more of gate drive teeth 160 may be removably connected to side surface 158 of gate 104. For example, gate 104 may have teeth receiving slots 162 (shown in FIG. 3) formed in side surface 158. Teeth receiving slots 162 and/or gate drive teeth 160 may be formed in any suitable manner such as via machining, cutting, laser cutting, molding, or any other suitable technique. For example, in an embodiment, gate drive teeth 160 may be cast, forged, or cut from solid plate steel, or other suitable materials. Each of teeth receiving slots 162 may be configured to receive individual gate drive teeth 160. In other embodiments, teeth receiving slots 162 may be configured to receive sets of gate drive teeth 160. For example, gate drive teeth 160 may be formed in sets or groups of two, three, four, five, or any other suitable number of gate drive teeth 160 which may then be inserted into and/or removed from teeth receiving slots 162 as a group or set. Such a configuration may allow gate drive teeth 160 to be easily replaced as needed. Thus, gate drive teeth 160 may be quickly and efficiently repaired without the need of replacing gate 104. For example, gate drive teeth 160 may be sized such that individually, in sets, or in groups, gate drive teeth 160 are relatively small and are easy to be changed by hand and/or with basic tools.

In an embodiment, gate drive teeth 160 may be customizable for different applications. For example, in a process application where extremely high temperatures (e.g., 1200° F.) may be experienced by valve assembly 100, gate drive teeth 160 exhibiting high melting points or low thermal expansion properties may be inserted in teeth receiving slots 162. By way of another example, in a process application where valve assembly 100 may be under high pressures (e.g., 2500 psi), gate drive teeth 160 exhibiting higher yield strengths may be inserted in teeth receiving slots 162. Moreover, gate drive teeth 160 may be sized and configured to minimize friction and wear. For example, in an embodiment, gate drive teeth 160 may be coated with one or more hard surface coatings to improve the operational life of gate drive teeth 160.

In an embodiment, one or more of drive teeth receiving slots 162 may exhibit a shape generally corresponding to at least a portion of a drive tooth 160. In other embodiments, one or more of teeth receiving slots 162 may exhibit a generally tapered shape such that gate drive teeth 160 may become wedged within teeth receiving slots 162. In yet other embodiments, teeth receiving slots 162 may exhibit any suitable shape and/or configuration.

Gate drive teeth 160 may be straight, tapered, rounded, and/or may exhibit any suitable shape suitable to fit within teeth receiving slots 162 and/or engage or mesh with worm drive assembly 170 (shown in FIG. 5). For example, gear drive teeth 160 may be generally triangular, generally square, generally rectangular, generally curved, or may exhibit any shape suitable to transmit generally constant angular velocity between gear drive teeth 160 and worm drive assembly 170. In addition, gear drive teeth 160 may be sized and configured to cooperate with different thicknesses of gate 104 and/or diameter of worm drive assembly 170. For example, gear drive teeth 160 may be generally elongated to cooperate with a thicker gate 104. In other embodiments, gear drive teeth 160 may extend along a greater portion of side surface 158 to move gate 104 greater distances to accommodate for a lager orifice 110 and/or gate orifice 156.

In an embodiment, gate drive teeth 160 may be sized and configured to fit into gate 104 with desired tolerances and to be retained in a secure manner. For example, gate 104 may further include a drive teeth retainer 164 on one or both of seating surfaces 154 of gate 104. Drive teeth retainer 164 may be configured to retain gate drive teeth 160 in position on gate 104. Drive teeth retainer 164 may be configured as a single piece and/or as a multi-piece system. In another embodiment, one or more of gate drive teeth 160 may include a head portion connected to a shaft portion and a lip extending from the shaft portion opposite the head portion. As shown, the shaft portion and the head portion of gate drive teeth 160 may have similar widths. One or more of teeth receiving slots 162 may include a slot formed therein that is configured to correspond to the lip of the gate drive teeth 160. When the lip of the gate drive teeth 160 is inserted into the slot of teeth receiving slots 162, gate drive teeth 160 may be more securely received within teeth receiving slots 162.

Similar to valve assembly, gate 104 may be configured to operate under severe service conditions. For example, gate 104 may include one or more high strength and/or chemical resistant materials. In an embodiment, gate 104 may be formed of steel, galvanized steel, stainless steel, iron, ductile iron, carbon steel, gun metal, alloy steel, alloy steels, one or more metal alloys, one or more polymeric materials, rubber, ceramics, composite materials, brass, combinations thereof, or any other suitable material. Moreover, while valve assembly 100 is described in relation to gate 104 and vice versa, it will be appreciated that any of the gate embodiments described herein may be used with valve assembly 100.

For example, FIG. 3 is a perspective view of a gate 304 according to another embodiment. Gate 304 has many of the same components and features that are included in gate 104 of FIG. 2. Therefore, in the interest of brevity, the components and features of gate 304 and 104 that correspond have been provided with the same or similar reference numbers, and an explanation thereof will not be repeated. However, it should be noted that the principles of gate 304 may be employed with any of the embodiments described with relation to FIGS. 1A through 2 and vice versa. Gate 304 may include a gate orifice 356 through which process media and/or other materials may flow when gate 304 is in an open position. Gate 304 may further include one or more gate control trim inserts 364 configured to influence flow conditions through gate orifice 356. For example, gate control trim inserts 364 may be positioned to obstruct a portion of gate orifice 356 thereby reducing the flow area through gate orifice 356. With a reduced flow area, flow velocity through gate orifice 356 may be increased. Gate control trim inserts 364 may be integral to or removably connected to gate 304. For example, gate control trim inserts 364 may be selectively inserted in trim insert slots 366 formed in a periphery of gate orifice 356 and a trim insert retainer 368 may be positioned on one or more both of seating surfaces 354 of gate 304 to retain the position of gate control trim inserts 364.

Gate 304 may include a plurality of gate drive teeth 360 extending along at least a portion of a side surface 358 of gate 304. Similar to gear drive teeth 160, gear drive teeth 360 may exhibit any suitable shape. For example, in an embodiment, gear drive teeth 360 may include one or more gate drive teeth 360B including a shaft portion having a width that is less than a width of a head portion of the gear drive teeth 360B. In other embodiments, gear drive teeth 360 may include one or more gate drive teeth 360A including a shaft portion having a width that is generally equivalent to or greater than a width of a head portion. In other embodiments, gear drive teeth 360 may include a head portion having a thickness that is greater or less than a thickness of a shaft portion or main body portion of gear drive teeth 360. In yet other embodiments, gear drive teeth 360 may be generally triangular, generally square, generally rectangular, generally curved, or may exhibit any shape suitable to transmit generally constant angular velocity between gear drive teeth 360 and worm drive assembly 170 (shown in FIG. 5), for example. In addition, gear drive teeth 360 may be sized and configured to cooperate with different thicknesses of gate 304 and/or diameter of worm drive assembly 170.

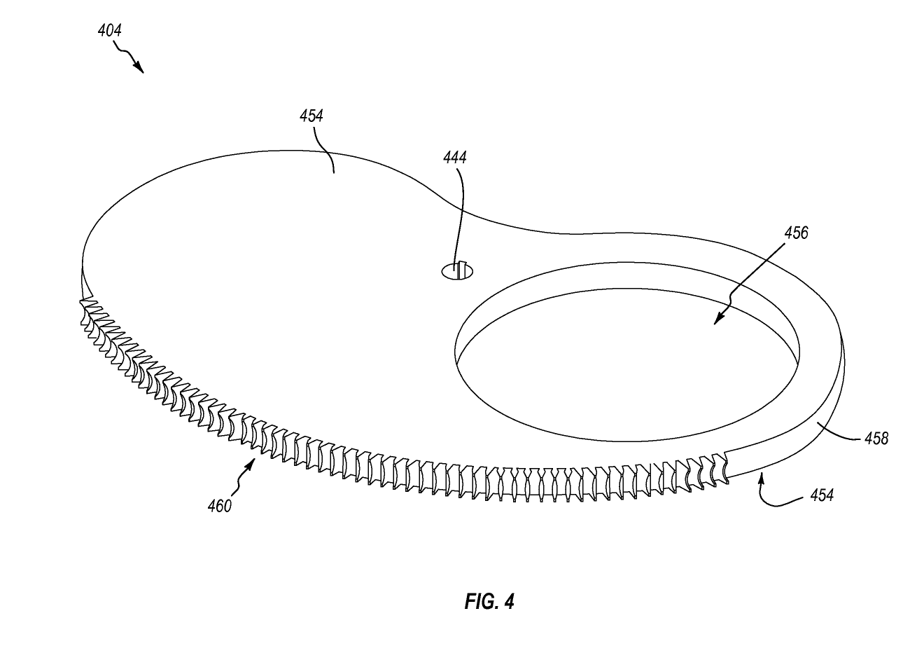

FIG. 4 is a perspective view of a gate 404 according to another embodiment. Gate 404 has many of the same components and features that are included in gates 104 and 304 of FIGS. 2 and 3. Therefore, in the interest of brevity, the components and features of gates 404, 304, and 104 that correspond have been provided with the same or similar reference numbers, and an explanation thereof will not be repeated. However, it should be noted that the principles of gate 404 may be employed with any of the embodiments described with relation to FIGS. 1A through 3 and vice versa. Gate 404 may have a generally irregular geometric shape configured to efficiently move through valve chamber 112. For example, moving from the closed position to the open position, a portion of seating surfaces 454 of gate 404 on the side of pivot point shaft receiver 444 opposite a gate orifice 456 formed in gate 404 may be configured to move along an arcuate path to be positioned within the valve chamber 112 of one of valve bonnets 108. The same movement of gate 404 may also move gate orifice 456 out of the valve chamber 112 of the other valve bonnet 108. Such a configuration may help reduce the size and weight of valve assembly 400 by limiting the space occupied by gate 404 within valve chamber 112.

Gate 404 may further include a plurality of gate drive teeth 460 extending along at least a portion of a side surface 458 of gate 404. In an embodiment, gate drive teeth 460 may be configured to engage or mesh with worm gear assembly 170 or any other suitable gear assembly. Gate drive teeth 460 may be formed integral to side surface 458 of gate 304. Gate drive teeth 460 may be formed in any suitable manner. For example, gate drive teeth 460 may be formed via machining, cutting, laser cutting, molding, or any other suitable technique.

Valve assembly 100 may include one or more features configured to move gate 104 between the open and closed positions. FIG. 5 illustrates a gate drive system 116 according to an embodiment. For example, gate drive system 116 may include worm gear assembly 170 positioned and configured to move gate 104 between the open and closed positions. When worm gear assembly 170 rotates, worm gear assembly 170 may mesh or engage gate drive teeth 160 such that the rotational force from worm gear assembly 170 is transmitted to gate 104 to move gate 104 between the open and closed position. The large contact area between worm gear assembly 170 and gate drive teeth 160 may help increase the strength, force, and/or power of gate 104 as gate 104 moves between the open and closed positions. Such a configuration may help gate 104 shear off process media, residual build-up (e.g., coke), and/or debris that may accumulate on seating surfaces 154 of gate 104 when seating surfaces 154 are positioned within orifice 110. Worm gear assembly 170 may be a right-hand worm gear assembly, a left-hand worm gear assembly, a single thread worm gear assembly, a multiple thread worm gear assembly, or any other suitable type of worm gear assembly. Moreover, while worm gear assembly 170 is shown and described, in other embodiments, valve assembly 100 may include any type of gear assembly suitable to move gate 104 between the open and closed positions. For example, valve assembly 100 may include a spur gear, a general helical gear, or the like.

In an embodiment, an actuator 178 may be connected to an actuator drive shaft 180, which is attached to worm gear assembly 170, which is the connection between gate drive system 116 and gate 104. In other embodiments, actuator 178 may be connected directly to worm gear assembly 170. Actuator 178 may be configured to control rotation of worm gear assembly 170 to move gate 104 between the open and closed positions. For example, when actuator 170 turns, actuator drive shaft 180 and worm gear assembly 170 are turned to move gate 104 between the open and closed positions.

In an embodiment, actuator 178 may comprise an electric multi-turn actuator. Such a configuration may allow gate drive system 116 to generate significant torque while utilizing minimal space. For example, electric multi-turn actuator 178 may be configured to turn worm gear assembly 170 in a first direction and/or a second direction without expansion of electric multi-turn actuator 178. While an electric multi-turn actuator 178 is described, worm gear assembly 170 may be actuated by various different means. For example, actuation may be hydraulic, electric, pneumatic, manual, electric-hydraulic, combinations thereof, or any other suitable type of actuation.

In addition to moving gate 104 between the open and closed positions, worm gear assembly 170, actuator drive shaft 180, and/or actuator 178 may be configured to at least partially support gate 104 within valve body 106. Such a configuration may help reduce loads exerted on pivot point shaft 136 by gate 104. In addition, such a configuration may help increase the shearing forces or other types of forces created by gate 104 as gate 104 moves between the open and closed positions.

Gate drive system 116 may further include a gear box 172 attached to an opening 146 (shown in FIG. 6) in valve body 106. Gear box 172 may be configured to house at least worm drive assembly 170 and may include one or more gearbox purge ports 176. As discussed below, gearbox purge ports 176 may be configured to purge, drain, rinse, inspect, and/or perform other maintenance or testing tasks related to gate drive system 116 and/or valve assembly 100. While gate drive system 116 is shown being attached to valve body 106, in other embodiments, gate drive system 116 may be positioned within valve assembly 100.

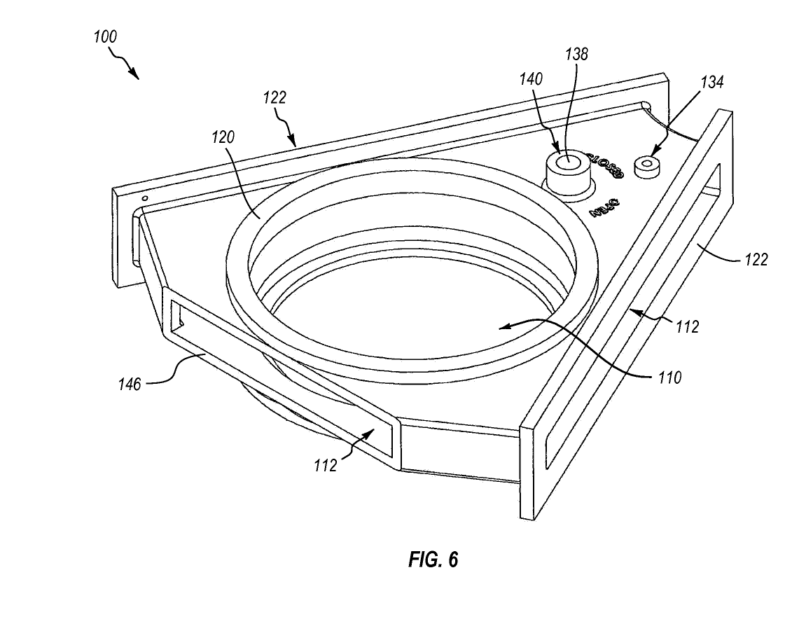

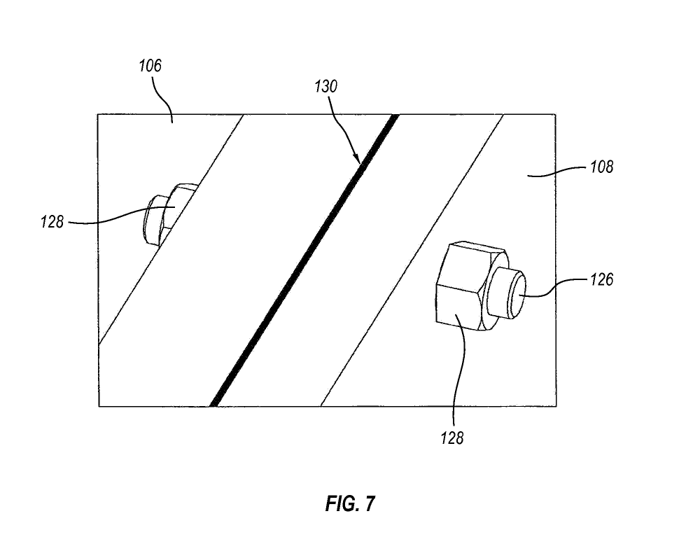

FIG. 6 illustrates valve body 106 according to an embodiment. Valve body 106 may include orifice 110 extending therethrough and at least a portion of valve chamber 112 therein. Valve body 106 may further be configured to receive and retain seat assembly 114 within valve body 106. In addition, valve body 106 may include one or more features configured to connect valve body 106 to valve bonnets 108, gate drive system 116, couplings, pipes, or vessels, and/or other components. For example, valve body 106 may include process mating flanges 120 configured to allow valve body 106 to be connected to process piping, couplings, and/or vessels. In an embodiment, valve body 106 may also include one or more body mating flanges 122 configured to allow valve bonnets 108 to be connected or mated to valve body 106. As shown, in the illustrated embodiment, body mating flanges 122 may be located on opposite sides of valve body 106. As discussed in more detail below, each valve bonnet 108 may include a valve bonnet mating flange 124 (shown in FIG. 8) configured to correspond to at least one of body mating flange 122. Valve body 106 may be connected or mated to valve bonnets 108 in any suitable manner. For example, in an embodiment, valve bonnet mating flanges 124 and body mating flanges 122 may be connected together via mechanical fasteners such as one or more studs 126 and nuts 128 as shown in FIG. 7. In an embodiment, a gasket 130 may be positioned between at least one of valve bonnet mating flanges 124 and body mating flanges 122 to form a tight seal between them. In other embodiments, one or both of valve bonnets 108 may be welded to body mating flanges 122. In yet other embodiments, one or more of valve bonnets 108 may be integral to valve body 106. In other embodiments, valve bonnet mating flanges 124 and body mating flanges 122 may be connected together via screws, clamps, quick-release clips or the like. Valve body 106 may further include an opening 146 such that gear box 172 may be attached to valve body 106.

Referring again to FIG. 6, valve body 106 may further be configured to receive pivot point shaft 136 (shown in FIG. 1B). As noted above, pivot point shaft 136 may define the rotation axis or axis of rotation for gate 104. In an embodiment, pivot point shaft 136 may penetrate through opposite sides of valve body 106 through a pivot point port 138. In other embodiments, pivot point shaft 136 may penetrate through a single side of valve body 106 or pivot point shaft 136 may not penetrate through any side of valve body 106. Pivot point port 138 may be sealed with a blind flange (not shown) or a pivot point packing gland 140 configured to prevent pressurized media within valve body 106 from escaping into the atmosphere. For example, in an embodiment, pivot point shaft 136 may be sealed to valve body 106 by pivot point packing gland 140 on one side of valve body 106 and may rotate on a bearing surface associated with blind flange on the opposite side of valve body 106. In other embodiments, pivot point shaft 136 may be fixedly attached to valve body 106. As discussed below, pivot point shaft 136 may further be configured to provide visible, exterior indication of the position of gate 104.

Pivot point shaft 136 may be connected to gate 104 in any suitable manner. For example, in an embodiment, pivot point shaft 136 may be connected to gate 104 via pivot point shaft receiver 144 (shown in FIG. 2) formed in gate 104, key in keyway connection. In other embodiments, pivot point shaft 136 may be connected to gate 104 via a pinned connection, a hinged connection, a ball-joint type connection, a weld, mechanical fasteners, or any other suitable type of connection. In other embodiments, pivot point shaft 136 may be formed integral to gate 104.

Valve body 106 may also include one or more body purge ports 134 configured to purge, drain, rinse, inspect, and/or perform other maintenance or testing tasks related to valve body 106 and/or valve assembly 100. For example, in an embodiment, a user or operator may utilize body purge ports 134 to remove contamination from valve body 106. To help gate 104 form a seal or barrier between the upstream and downstream side of valve assembly 100, valve body 106 and valve bonnets 108 may be frequently purged. Purging means the inside of the unit pressurized to a level higher than that of a process either upstream or downstream, which helps prevent process media from crossing from one side of valve assembly 100 to another. Purge media may take a variety of forms including steam. In an embodiment, valve body 106 may be purged via body purge port 134. Such a configuration may allow for convenient and safe maintenance, repairs, and/or testing of valve assembly 100 in the field with basic tools and without the need of dissembling valve assembly 100.

Position indication may be accomplished in a variety of different ways. FIG. 8 illustrates a position indicator 132 according to an embodiment. Position indicator 132 may comprise an arrow 142 or other viewable structure attached to pivot point shaft 136 that is connected to gate 104. When gate 104 is actuated back and forth, pivot point shaft 136 will rotate with gate 104. Arrow 142 may be connected to an end portion of pivot point shaft 136 such that arrow 142 is visible on an exterior of valve body 106. In an embodiment, arrow 142 may be synchronized with indictors on valve body 106 such as “OPEN” and “CLOSED” that display the position of gate 104 or valve assembly 100 relative to being open or closed, or at any point between the open and closed positions. In addition, position indicator 132 may be configured to indicate the position of gate 104 relative to seats 182, 184 of seat assembly 114.

In another embodiment, position indicator 132 may include one or more sensors or transducers associated with gate 104, valve body 106, and/or seating assembly 114 configured to gather data and transmit signals indicative of the position of gate 104. The one or more sensors or transducers may include pressure sensors, electromechanical sensors, electronic sensors, flow sensors, motion sensors, combinations thereof, or any other suitable type of sensor. In an embodiment, a computing device or monitoring station may be configured to receive the signals from the sensors and display the position of gate 104 to a user or operator. It will be appreciated that the computing device described herein may include any suitable computing device including personal computers, desktop computers, laptop computers, message processors, hand-held devices, multi-processor systems, microprocessor-based or programmable consumer electronics, network PCs, minicomputers, mainframe computers, mobile telephones, PDAs, tablets, combinations thereof, or the like.

In an embodiment, the sensors or transducers may be configured to be monitored remotely from one or more different locations. In other embodiments, position indicator 132 may include a mechanical means such as arrow 142 connected to pivot point shaft 136 configured to display the position of gate 104 on valve body 106 combined with one or more sensors that can be monitored remotely.

Similar to valve assembly 100, valve body 106 may be configured to operate under severe service conditions. For example, valve body 106 may include one or more high strength and/or chemical resistant materials. In an embodiment, valve body 106 may be formed of steel, galvanized steel, stainless steel, iron, ductile iron, carbon steel, gun metal, alloy steel, alloy steels, one or more metal alloys, one or more polymeric materials, combinations thereof, or any other suitable material.

FIG. 9 illustrates one of valve bonnets 108 according to an embodiment. While only one valve bonnet 108 is shown and described with reference to FIG. 9, it should be noted that the principles of the valve bonnet 108 shown in FIG. 9 may be employed with the other valve bonnet shown in FIG. 1A. Valve bonnet 108 may include a body mating flange 124 configured to connect or mate with one of body mating flanges 122 of valve body 106. For example, in an embodiment, valve bonnet mating flanges 124 and body mating flanges 122 may be connected together via mechanical fasteners such as one or more studs 126 and nuts 128, screws, clamps, quick-release clips or the like.

Valve bonnet 108 may be configured to contain severe service pressures. For example, in an embodiment, valve bonnet 108 may include a bonnet shell wall 148 and a plurality of structural stiffeners 150 that in combination or alone may form a pressure containing component configured to resist deformation as a result of elevated temperatures and/or high pressure being exerted on valve bonnet 108. In other embodiments, the structural stiffeners may be omitted. For example, bonnet shell wall 148 may exhibit a thickness that may help bonnet shell wall 148 withstand or contain elevated temperatures and/or high pressures with or without structural stiffeners 150. In another embodiment, bonnet shell wall 148 may include one or more materials exhibiting structural properties that may help bonnet shell wall 148 withstand or contain elevated temperatures and/or high pressures with or without structural stiffeners 150.

In an embodiment, an end of one or more of valve bonnets 108 may include a blind flange 152 removably connected to valve bonnet 108. Blind flange 152 may be connected to valve bonnet 108 by any suitable means. For example, blind flange 152 may be connected to valve bonnet 108 via studs, nuts, and gasket configured to create a tight seal between blind flange 152 and valve bonnet 108. In other embodiments, blind flange 152 may be connected to valve bonnet 108 via screws, clamps, quick-release clips, or the like. In an embodiment, blind flange 152 may be removed to inspect and/or access components within valve chamber 112. Such a configuration may allow for convenient and safe maintenance, repairs, and/or testing of valve assembly 100 in the field with basic tools and without the need of dissembling valve assembly 100. In addition, valve bonnet 108 may include one or more bonnet purge ports 154 configured similar to body purge ports 134 such that valve bonnets 108 and/or valve body 106 may be purged via body purge ports 134 and/or drained, rinsed, inspected, or the like.

In an embodiment, valve bonnet 108 may be configured to form a close tolerance fit between an inside wall of valve bonnet 108 and a seating surface 154 of gate 104. Such a configuration may help ensure that if gate 104 closes while process media and/or other materials are still within a gate orifice 156 formed in gate 104, the process media and/or other materials do not migrate or deposit inside either of valve bonnets 108 during gate 104 movement. Rather, such process media and/or materials may instead remain in gate orifice 156 until gate 104 moves back into the open position and the process media and/or other materials may be carried downstream by the flow process.

Similar to valve assembly 100, valve bonnets 108 may be configured to operate under severe service conditions. For example, valve bonnets 108 may include one or more high strength and/or chemical resistant materials. In an embodiment, valve bonnets 108 may be formed of steel, galvanized steel, stainless steel, iron, ductile iron, carbon steel, gun metal, alloy steel, alloy steels, one or more metal alloys, one or more polymeric materials, combinations thereof, or any other suitable material.

FIG. 10A illustrates a seat assembly 114 according to an embodiment. As shown, seat assembly 114 may include seats 182, 184. In an embodiment, seats 182, 184 may be positioned in valve body 106 and gate 104 may be positioned between seat 182 and seat 184. Gate 104 may move between the open and closed positions between seats 182, 184.

Seats 182, 184 may be configured in any suitable manner. For example, seats 182, 184 may be configured as ring structures and may be formed of forged steel, galvanized steel, metal alloys, cast iron, ductile iron, cast carbon steel, or other suitable materials. In other embodiments, seats 182, 184 may be configured as rectangular plates with apertures formed therein, as annular members, or in any other suitable manner. In other embodiments, seats 182, 184 may include one or more semi-rigid and/or flexible materials. In yet other embodiments, at least one of seats 182, 184 may be dynamic and/or adjustable based upon a selected application. In an embodiment, seats 182, 184 may include one or more rigid materials such that mechanical compression may maintain seats 182, 184 in contact with gate 104. In other embodiments, seats 182, 184 may be resiliently forced against gate 104. For example, in an embodiment, one or more spring members, one or more resilient members, one or more bladders, or the like may resiliently force seats 182, 184 against gate 104. Optionally, seat assembly 114 may include one or more seat retainers 190 configured to retain seats 182, 184 within valve body 106.

Seats 182, 184 may include seating surfaces 186 configured to contact seating surfaces 154 of gate 104 to form a seal between gate 104 and seats 182, 184. In an embodiment, seating surfaces 186 may be planar, smooth, and/or generally parallel to one another. In other embodiments, seating surfaces 186 may be curved and/or contoured. In other embodiments, at least one of seating surfaces 186 may be angled or tapered relative to the other seating surface 186. For example, in an embodiment, seating surfaces 186 may be tapered so as to form a wedge-like shape. In an embodiment, one or more of seating surfaces 186 of seats 182, 184 may be tapered and one or more of seating surfaces 154 of gate 104 may be planar such that as gate 104 moves over seats 182, 184, gate 104 may become generally wedged between seats 182, 184. In other embodiments, one or more of seating surfaces 154 of gate may be tapered and one or more of seating surfaces 186 of seats 182, 184 may be planar. Such a configuration may allow for increased seating and/or sealing force between the seats 182, 184 and gate 104 the further gate 104 is rotated over seats 182, 184.

Seats 182, 184 may exhibit a variety of different configurations. For example, seats 182, 184 may include generally planar, generally parallel seating surfaces 186 as shown in FIG. 10B. In an embodiment, seating surfaces 186 may be beveled. In another embodiment, seats 182, 184 may include seating surfaces 186 having a generally planar portion and an angled portion as shown in FIG. 10C. Moreover, as shown in FIG. 10C, seats 182, 184 may include seat purge channels 188. In an embodiment, seat purge channels 188 may be configured to help keep seats 182, 184 and/or seating surfaces 154 of gate 104 clean by directing one or more bursts of purge media across seats 182, 184 and/or seating surfaces 154 of gate 104 as gate 104 moves between the open and closed positions. In an embodiment, as gate 104 moves between the open and closed positions, purge pressure built up within valve assembly 100 is quickly released and flows over seats 182, 184 and/or seating surfaces 154 and forces any process media and/or other material off of seats 182, 184 and/or seating surfaces 154 and back down a pipeline or the like. In an embodiment, when gate 104 reaches the open and/or closed position, seats 182, 184 and seating surfaces 154 may form a seal. Because of the seal, purge pressure within valve assembly 100 may increase to a predetermined purge pressure. In an embodiment, seat purge channels 188 may be operatively connected to body purge ports 134 to control the timing and/or flow of purge media to seats 182, 184 and/or valve body 106.

In an embodiment, seats 182, 184 may include generally curved seating surfaces 186 as shown in FIG. 10D. In another embodiment, seats 182, 184 may include generally rounded seating surfaces 186 as shown in FIG. 10E. In yet other embodiments, seats 182, 184 may include seating surfaces 186 having a planar portion between a pair of generally rounded portions as shown in FIG. 10F. In an embodiment, seats 182, 184 may include seating surfaces 186 having a curved portion between a pair of angled portions as shown in FIG. 10G. In yet other embodiments, seats 182, 184 may include seating surfaces 186 having a planar portion between a pair of angled portions as shown in FIG. 10H.

Like other components of valve assembly 100, seats 182, 184 may be configured to be compliant with valve standards and codes for different applications or services such as severe service applications. For example, valve body 106 may include one or more high strength and/or chemical resistant materials. In an embodiment, valve body 106 may be formed of steel, galvanized steel, stainless steel, iron, ductile iron, carbon steel, gun metal, alloy steel, alloy steels, one or more metal alloys, one or more polymeric materials, combinations thereof, or any other suitable material.

FIG. 11 illustrates support members 118 according to an embodiment. As shown, one or more support members 118 may be integral to or removable from valve bonnets 108 and/or valve body 106. In an embodiment, support members 118 may be configured to support gear drive system 116 and/or valve assembly 100. In an embodiment, support members 118 may be configured to stabilize and/or protect gear drive system 116 from impact forces. For example, support members 118 may support legs 118A and a stabilizer plate 118B configured to protect gear drive system 116 from heavy equipment or tools accidently hitting valve assembly 100. In another embodiment, support members 118 may be configured as support legs 118A configured to support valve assembly 100 such that valve assembly 100 may be positioned vertically for storage and/or transportation. For example, larger valve assemblies (e.g., valve assemblies having orifices exhibiting 48-inch diameters) may be too large to transport on standard 8-ft wide trailers or trucks. By attaching support legs 118 to valve body 106 and/or valve bonnets 108, valve assembly 100 may be positioned vertically such that larger valve assemblies may fit on standard 8-ft wide trailers, trucks, or the like for transportation. Such a configuration may allow for large valve assemblies to be transported economically by traditional truck, trailer, or other means.

Any of the valve assembly embodiments described herein may be utilized in a variety of different isolation and/or control applications. For example, any of the valve assemblies described herein may be utilized in applications such as chemical processing, power generation, petrochemical processing, nuclear power generation, refining, and/or other severe service type applications. Moreover, any of the valve assemblies described herein may be utilized in a variety of non-severe service applications such as fire suppression, agricultural, light industry, or the like.

While various aspects and embodiments have been disclosed herein, other aspects and embodiments are contemplated. The various aspects and embodiments disclosed herein are for purposes of illustration and are not intended to be limiting. Additionally, the words “including,” “having,” and variants thereof (e.g., “includes” and “has”) as used herein, including the claims, shall be open ended and have the same meaning as the word “comprising” and variants thereof (e.g., “comprise” and “comprises”).

What is claimed is:

1. A valve assembly comprising:
a housing having an orifice defining a flow path through said housing;
a valve closure element positioned within said housing and configured to control fluid flow through said housing, said valve closure element including a side surface and a plurality of drive teeth extending along at least a portion of said side surface, said valve closure element being selectively rotatable about a rotation axis to move said valve closure element between an open position, wherein fluid flows through said orifice, and a closed position, wherein fluid flow through said orifice is substantially obstructed by said valve closure element; and
a worm gear assembly positioned and configured to selectively engage or mesh with one or more of said drive teeth such that rotation of said worm gear assembly rotates said valve closure element about said rotation axis to move said valve closure element between said closed position and said open position; and
a seat assembly positioned within said housing, said seat assembly configured to form and/or maintain a seal between at least said valve closure element and said seat assembly.

2. The valve assembly of claim 1, wherein said valve closure element has a generally elliptical shape or a generally kidney-like shape.

3. The valve assembly of claim 1, wherein said rotation axis is offset from a geometric center of said valve closure element.

4. The valve assembly of claim 1, wherein one or more of said gear teeth are interchangeable or removable.

5. The valve assembly of claim 4, further comprising:
a plurality of teeth receiving slots formed in at least a portion of said side surface of said valve closure element, each of said teeth receiving slots configured to selectively receive and secure one of said drive teeth therein; and
one or more drive teeth retainer assemblies attached to said valve closure element, said one or more drive teeth retainer assemblies configured to selectively secure said drive teeth within said teeth receiving slots.

6. The valve assembly of claim 4, wherein at least one of said teeth receiving slots includes a cross-sectional area that tapers between a first end portion and a second portion.

7. The valve assembly of claim 1, further comprising:
one or more actuators operably connected to said worm gear assembly, said one or more actuators configured to control rotation of said worm gear assembly to move said valve closure element between said open position and said closed position.

8. The valve assembly of claim 7, wherein said one or more actuators comprise an electric multi-turn actuator.

9. The valve assembly of claim 7, wherein said one or more actuators are further configured to rotate said worm gear assembly in a first direction and a second direction generally opposite said first direction.

10. The valve assembly of claim 7, wherein at least one of said one or more actuators or said worm gear assembly is configured to at least partially support said valve closure element.

11. The valve assembly of claim 1, further comprising a pivot point shaft extending along said rotation axis, said valve closure element being connected to said pivot point shaft.

12. The valve assembly of claim 10, wherein said housing includes a pivot point shaft port formed therein, and wherein at least a portion of said pivot point shaft is received within said pivot point shaft port and configured to rotate on a bearing surface formed by a blind flange.

13. The valve assembly of claim 12, further comprising a position indicator connected to said pivot point shaft, said position indicator configured to indicate movement of valve closure element between said open position and said closed position.

14. The valve assembly of claim 1, wherein said housing comprises a main body and a first valve bonnet and a second valve bonnet removably coupled to opposing ends of said main body.

15. The valve assembly of claim 14, wherein at least one of said first valve bonnet or said second valve bonnet includes a removable blind flange configured to allow access to said valve closure element and/or said seat assembly.

16. The valve assembly of claim 1, further comprising:
a gear box attached to said housing, said gear box configured to house and support said worm gear assembly and/or said one or more actuators.

17. A valve assembly comprising:
a valve body having a flow orifice extending therethrough;
a first valve bonnet removably coupled to a first end of said valve body and a second valve bonnet removably coupled to a second end of said valve body;
a valve chamber at least partially defined by said valve body, said first valve bonnet, and said second valve bonnet;
an elliptical or kidney-like shaped gate positioned within said chamber and configured to control fluid flow through said flow orifice, said gate including a gate orifice extending therethrough, a side surface, and a plurality of gate drive teeth extending along at least a portion of said side surface, said gate being selectively rotatable about a rotation axis between an open position, wherein said flow orifice and said gate orifice are at least partially aligned, and a closed position, wherein a solid portion of said gate obstructs said flow orifice;
a worm gear assembly positioned and configured to selectively engage or mesh with one or more of said drive teeth, wherein rotation of said worm gear assembly rotates said gate about said rotation axis to move said gate between said closed position and said open position; and
a seat assembly positioned within said chamber and configured to form and/or maintain a seal between at least said gate and said seat assembly.

18. The valve assembly of claim 17, wherein said gear assembly comprises a worm gear assembly.

19. A method of controlling fluid flow through a gate valve, the method comprising:
connecting a gate valve to a vessel, coupling, or a pipeline, wherein said gate valve includes:
a housing having an orifice defining a flow path through said gate valve;
a generally elliptical or generally kidney shaped gate positioned within said housing and configured to control process media flow through said gate valve, said gate including a side surface and a plurality of gate drive teeth extending along at least a portion of said side surface, said gate being selectively rotatable about a rotation axis between an open position, wherein process media flows through said gate valve, and a closed position, wherein process media flow through said gate valve is substantially obstructed by said gate; and
a worm gear assembly positioned and configured to selectively engage one or more of said gate drive teeth, wherein rotation of said worm gear assembly rotates said gate about said rotation axis to move said gate between said closed position and said open position; and
an actuator operably connected to said worm gear assembly, said actuator configured to control rotation of said worm gear assembly to move said gate between said open position and said closed position; and
controlling process media flow through said gate valve by controlling said worm gear assembly with said actuator.

20. The method of claim 19, wherein controlling fluid flow through said gate valve by controlling said worm gear assembly using said actuator comprises rotating said worm gear assembly in a first direction and a second direction generally opposite said first direction.
